(19) United States
(12) Patent Application Publication
(10) Pub. No.: US 2022/0404601 A1
(43) Pub. Date: Dec. 22, 2022

(54) SYSTEM AND METHODS FOR DIFFERENTIAL IMAGING USING A LOCK-IN CAMERA

(71) Applicant: ECOLE POLYTECHNIQUE FEDERALE DE LAUSANNE (EPFL), Lausanne (CH)

(72) Inventors: Damien LOTERIE, Ecublens (CH); Chiara BONATI, Ecublens (CH); Timothé LAFOREST, Crozet (FR); Christophe MOSER, Lausanne (CH)

(21) Appl. No.: 17/764,089

(22) PCT Filed: Sep. 17, 2020
(86) PCT No.: PCT/EP2020/075968

§ 371 Date: Mar. 25, 2022

(30) Foreign Application Priority Data
Sep. 26, 2019 (EP) 19199760.0

(51) Int. Cl. G02B 21/14; G02B 21/36; G02B 21/08

(52) U.S. Cl. CPC G02B 21/14; G02B 21/367; G02B 21/088

(57) ABSTRACT

The present invention describes an imaging system that allows visualization of a wide range of samples both in terms of morphology and in terms of material (e.g. density distribution, varying chemical composition, or anything that induces a change of optical path). The application of this imaging system includes absorptive samples as well as nearly and fully transparent samples with respect to the wavelength of illumination.

Two elements are key in this system: the use of a so-called lock-in camera, and the synchronization of the recording to a modulation of choice along the image forming apparatus. Such modulation can consist for example in modulation of the illumination, use of filters, tilt/rotation of the sample or of certain microscope components.

### BACKGROUND OF THE INVENTION

### 1. Field of the Invention

The present invention relates to systems and methods of imaging that use a lock-in camera to record an image of a sample which is formed by the difference in optical appearance of said sample between two time points of the sample via a lock-in camera.

### 2. Background Art

Imaging of numerous biological samples is a challenging task due to their transparency with respect to light in the visible range.

Indeed, standard microscopes provide information regarding the distribution of the absorption properties of a given sample. As the electric field from a light source propagates through the sample, it is modulated by its absorption. A set of optical components forms an image of this modulated field onto a detector, which measures the intensity of the field. The absorption distribution of the sample is directly related to the intensity of the detector image.

Transparent samples only introduce a so-called phase modulation of the electric field propagating through said samples. This modulation can be due to a variation of local refractive index or to a difference in the sample thickness. The collective effect of these quantities is expressed by the “optical path length” (OPL), which corresponds to an imaginary exponential term that is invisible in the intensity pattern on the detector. This term is often referred to as “phase”, since it only shifts the oscillations of the complex electric field.

Still, this type of modulation can be recovered with other techniques.

Interferometric techniques allow the measurement of the phase by means of interference between the light that propagates through the sample and a reference field. These techniques require the use of coherent light, bringing a series of disadvantages like the presence of speckle noise, defocus artifacts and diffraction rings.

Another class is that of non-interferometric techniques. These typically consist in some modification of the optical system which transforms the phase variation into a real modulation, which is then directly recorded onto a detector.

Examples of such modifications are the introduction of phase plates on the optical axis, the use of split detection, or, equivalently, asymmetric illumination (see Mehta S. et al., Quantitative phase-gradient imaging at high resolution with asymmetric illumination-based differential phase contrast, Optics Letters, vol. 34, 13, 2009; Tian, L. and Waller, L. Quantitative differential phase contrast imaging in an LED array microscope. Optics Express. 2015, Vol. 23, 9.).

The phase to intensity information encoded in the images obtained with these setups cannot be readily interpreted as “phase”, but it is related to the phase via an equation that is defined by the microscope configuration and parameters. In order to retrieve the phase, an inversion of the equation must be performed.

Methods based on asymmetric illumination require subtracting two images of the sample, where in the second image the geometry of one of the optical elements is mirrored with respect to the optical axis. For example, if a certain illumination profile is used in the first image, this illumination profile is mirrored when recording the second image. In this way, after subtraction, the unwanted background is eliminated, and only the relevant information related to the phase is retained (see Tian, L. and Waller, L. Quantitative differential phase contrast imaging in an LED array microscope. Optics Express. 2015, Vol. 23, 9.). In samples with low absorption contrast and small phase variations, the first and second image separately will show a strong background with small modulations related to the sample phase variation. The background is the same in both images, but the modulation related to the sample is different in each image. In theory, subtracting one image from the other removes the background term, leaving only the difference in modulations related to the phase. In practice, measurement noise (readout noise, quantization noise, etc.) can make it difficult or impossible to recover the desired modulation signal in this way. Considering a typical zero-mean, independent Gaussian distribution approximation of noise in imaging systems, upon subtraction of two images with identical noise variance, the resulting distribution will show a variance that is double. This fact can greatly impact the ability to observe phase variations, especially when the signal to noise ratio (SNR) of a single image is low.

It was the problem underlying the present invention to overcome the above described drawbacks from the prior art and to specifically provide an imaging system that is widely applicable, including nearly and fully transparent samples with respect to light in the visible range, and provides improved results.

The above problem has been successfully solved by the present invention.

### SUMMARY OF THE INVENTION

The invention described herein allows to directly obtain, as an output, the difference image through a synchronized lock-in detection at the pixel level. In this way, the entire dynamic range of the camera is spent solely on the differential phase information (and not the background), thus circumventing the need of making the difference of two noisy images. The proposed method results in a greatly increased sensitivity to phase and an optimized use of the bit depth to encode the relevant sample structures with no background. As an example, with Heliotis's 10-bit detector, it is possible to increase the digital sampling up to 10 times and the SNR up to 5 times, with the current illumination system.

In detail, the present invention is related to an imaging system comprising at least one incoherent illumination source which can be switched or modulated between different states in synchronization with a lock-in signal, and a lock-in image sensor to perform lock-in amplification of a difference image at the pixel level.

The present invention describes an optical system, such as but not limited to a microscope, that allows visualization of a wide range of samples both in terms of morphology and in terms of material (e.g. density distribution, varying chemical composition, or anything that induces a change of optical path, light direction or absorption). The application of this optical system is not restricted to absorptive samples, but includes also nearly and fully transparent samples with respect to the wavelength of illumination.

Two elements are important in this system: the use of a so-called lock-in camera, and the synchronization of the recording to a modulation of choice along the image forming apparatus. Such modulation can comprise, for example, an illumination modulation, such as direction or spatial coding, use of filters, tilt/rotation of the sample or of certain microscope components. Some of these modulations will be described in more detail below.

### BRIEF DESCRIPTION OF THE DRAWINGS

These and other features, aspects and advantages of the present invention will become better understood with regard to the following description, appended claims and accompanying non-limiting drawings where:

FIG. 1: shows a general timing scheme for the synchronization to the reference sinusoidal signal A1 for lock-in detection to the modulation of system parameters.

FIG. 2: shows a scheme of one embodiment according to this invention. This setup can perform “differential phase contrast (DPC)” by asymmetric illumination.

FIG. 3a-c: shows three possible embodiments according to this invention of the asymmetrical illumination for DPC according to the setup of FIG. 2.

FIG. 4a-e: shows example images obtained from the setup of FIG. 2, where a normal camera was used instead of the lock-in camera.

FIG. 5: shows a timing scheme for the synchronization of the reference sinusoidal for lock-in amplification to the modulation of light in the embodiment according to this invention of FIG. 2.

FIG. 6: shows a scheme of one embodiment of this invention with two light sources. This setup can perform “differential phase contrast” by asymmetric illumination.

FIG. 7: shows a single image obtained with the setup of FIG. 6, with the camera (element 205) run in standard mode. The grey scale on the right shows the 1024 grey levels of the camera in standard mode.

FIG. 8: shows a difference image obtained with the standard differential phase contrast technique. The grey scale on the right shows the 1024 grey levels of the camera (from −511 to +512) that results from subtracting two standard-mode images.

FIG. 9: shows a lock-in differential phase contrast image of the sample. The grey scale on the right shows the 1024 grey levels of the camera in lock-in mode, which goes from −511 to 512.

FIG. 10: shows a lock-in differential phase contrast image of the illumination pattern difference. The grey scale on the right shows the 1024 grey levels of the camera in lock-in mode, which goes from −511 to 512.

FIG. 11a: shows a cross section of the rectangular structure obtained with standard differential phase contrast. The location of the cross-section is indicated with a blue line in FIG. 8; the vertical axis represents the grey level value, while the horizontal axis represents the pixel position.

FIG. 11b: shows a cross section of the rectangular structure obtained with lock-in differential phase contrast. The location of the cross-section is indicated with a blue line in FIG. 9; the vertical axis represents the grey level value, while the horizontal axis represents the pixel position.

### DETAILED DESCRIPTION

The system described here is an imaging setup that exploits the modulation of a given parameter in the imaging system to perform a lock-in amplification of the difference image between different states of said modulation.

In lock-in detection, a probing signal is first modulated by multiplication with a reference signal, which is typically a sinusoidal signal with a certain frequency f_{R}. This modulated probing signal interrogates a target. The resulting signal from the target is detected and is low-pass filtered, so that only the signal components that are at the same frequency f_{R} are retained, while all other contributions are strongly suppressed. This type of acquisition can be replicated over many “pixels”, which is the concept of lock-in cameras (for example the heliCam C3 by Heliotis). The use of lock-in cameras has been demonstrated for coherent interferometric microscopy systems.

According to the present invention, the lock-in camera is instead part of an imaging setup based on incoherent illumination and is used to recover the difference image between different states of modulation the optical system.

The key step of this invention comprises modulating one or more components of the imaging apparatus, in such a way that images with opposite contrasts are generated sequentially in time on the camera.

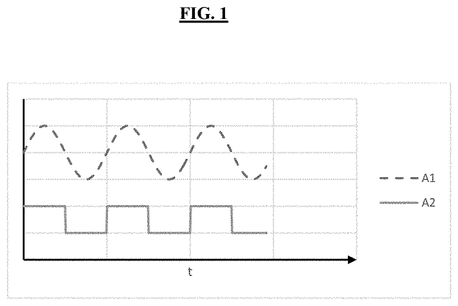

This modulation is synchronized in both frequency and phase to the reference sinusoidal signal of the lock-in camera. An example of the timing sequence for such an acquisition cycle is shown in FIG. 1. In this graph, the horizontal axis represents time t; the line A1 is the sinusoidal reference signal of the lock-in camera, while the line A2 represents the parameter that is being modulated (here switched). It can be seen that the two signals are synchronized. Both lines have the same frequency and are in phase. The modulation is here represented by a square wave A2 (switching between two defined states), but it can be also a continuous modulation. In this way, the lock-in camera will provide an output image in which the value of each pixel corresponds to the amplitude of the intensity variations caused by the modulation. According to the imaging configuration in use, this amplitude can be linked to a specific physical quantity.

As discussed in the introduction, thanks to the amplification provided by the lock-in technique, the resulting image is sensitive to very small variations against a strong background.

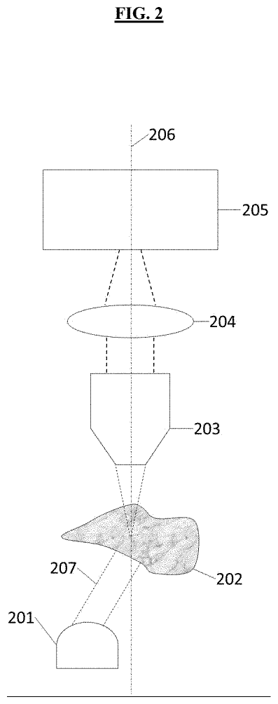

An example of an embodiment of this invention is schematically represented in FIG. 2. It illustrates an imaging setup designed to perform “differential phase contrast”. Element 201 is an incoherent source of light that emits an asymmetric pattern of light with respect to the optical axis. This source can be, but is not limited to, LEDs, filament lamps, or other incoherent light sources. Element 202 is a sample. Element 203 is an objective lens, for example an achromatic doublet, a composite objective lens, or other types of imaging lenses. Element 204 is a tube lens, e.g. an achromatic doublet or other type of imaging lens. Element 205 is a lock-in camera, e.g. Heliotis's Helicam c3. Element 206 represents the optical axis. Element 207 illustrates the propagation of a bundle of rays. In this embodiment, the use of oblique illumination allows to form an image on the detector such that it shows the OPL (optical path length) distribution on the sample, or equivalently, the phase shift that it introduces to the upcoming light. The physics behind this approach is described in Tian, L. and Waller, L. Quantitative differential phase contrast imaging in an LED array microscope. Optics Express. 2015, Vol. 23, 9.

The light from an incoherent source 201 is projected onto a sample 202 in the form of a bundle of propagating rays 207, with a certain asymmetry with respect to the optical axis 206.

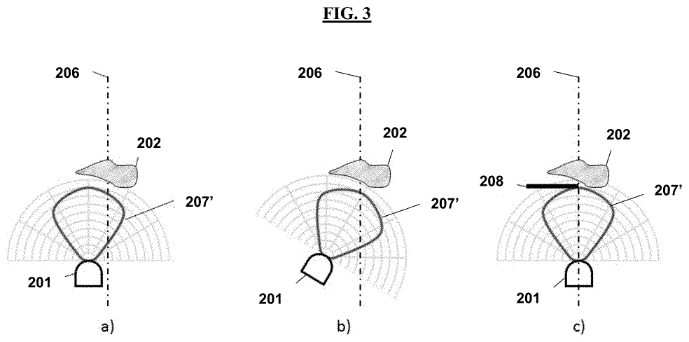

FIG. 3 shows examples of configurations providing this asymmetry:
In FIG. 3a, an incoherent source is shifted laterally with respect to the optical axis. Element 201 is the incoherent source (for example an LED, a lamp, or the output facet of a fiber). Element 207 is a polar graph of the angular emission of a typical LED source. Element 202 is the sample. Element 206 represents the optical axis.
In FIG. 3b, the source 201 is tilted with respect to the optical axis 206.
In FIG. 3c, part of the emission from the source 201 is blocked by an opaque stop element 208 located asymmetrically with respect to the optical axis 206.

This list is not limiting and any other configuration that generates an asymmetric angular distribution of the light intensity can be used without deviating from the scope of this invention.

After the light propagates through the sample 202, it is collected by an imaging system in the optical path between the sample 202 and the lock-in camera 205, that forms an image on the lock-in camera 205. In one embodiment of the invention, the imaging system is a microscope, where the light is first collimated by an objective lens 203, and then focused by a tube lens 204 giving a magnified image of the sample.

According to the theory described in Tian, L., Waller, L. Quantitative differential phase contrast imaging in an LED array microscope. Optics Express. 2015, Vol. 23, 9, the formed image will highlight the changes of phase that light undergoes when passing through the sample. When one of the modulations listed above takes place, a similar image is obtained, but with reversed contrast. As shown in the same paper, the absorption features of the sample will look the same in both images, so upon subtraction they are canceled. In this way only the relevant phase information is retained. Still, if the phase variations are very small, the single image will contain a strong background component with small modulations on top which, in the worst cases, might have amplitudes close to the noise level. The result of this subtraction is then a noisy, zero-mean image with low intensity features.

In the system according to the embodiment of the present invention shown in FIG. 2, the single image detection is substituted with the lock-in camera 205. The chosen modulation is set at a frequency identical to that of the reference sinusoidal signal of the lock-in camera 205 and in phase with the same.

In this way, the effective output of the camera is directly the “difference” image between the two states of the imaging system. Thanks to the synchronization to the reference sinusoidal signal, only the variation of intensity due to phase variations in the sample will be recorded in the image. Background and noise are strongly suppressed at the pixel level. The main advantages of this scheme are that:
It is possible to obtain a “full field” image (where all the pixel values are retrieved at the same time and not via a scanning mechanism);
The difference image is directly digitized inside the camera at the pixel-level, strongly reducing the noise in this difference image compared to the case where two separate recordings are subtracted;
Higher illumination power can be brought onto the detector without reaching saturation of its pixels, as the DC component is analogically removed by the camera itself; in a typical shot-noise limited configuration, when the intensity I increases, the noise only increases by \sqrt{I}, so being able to use more power without reaching saturation brings an improvement in the ratio between signal and noise, making detection more sensitive;
Other sources of noise, like source noise or vibration, that take place at frequencies not synchronized with the modulation fr, are also suppressed by the lock-in detection;
The acquisition speed is limited only by the modulation rate and the acquisition rate of the lock-in camera;

The relevant sample features are digitized over a much higher number of digital levels: the use of the bit depth is optimized and is used fully to encode the important structures, while none of the dynamic range is spent on encoding of the background level. It is important that the switched or modulated light is carefully tuned in such a way that the background it provides remains equal in the different images, in order to provide correct subtraction of said background. Differences in illumination will be amplified together with the relevant sample structures, so it is fundamental to minimize these differences in order to be able to take full advantage of the dynamic range without incurring in saturation. Preferably, two alternately switched sources of light are fine tuned to produce equal illumination, such that the lock-in amplification removes the equal background and more power can be used without reaching saturation. The increase of power from the light sources allows to increase the SNR and thus the sensitivity, and/or to optimize the encoding of relevant information over the whole bit depth.

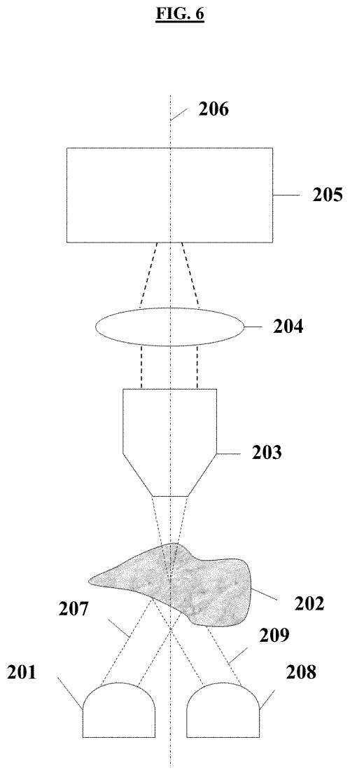

A more specific embodiment of this invention for differential phase contrast is shown in FIG. 6. This scheme shows the preferred illumination setup to perform DPC (differential phase contrast) according to this invention. Same numbers designate the same elements as in FIGS. 2 and 3. Element 201 is an incoherent source of light that emits and asymmetric pattern of light with respect to the optical axis 206. Element 202 is a sample. Element 203 is a microscopy objective. Element 204 is a tube lens. Element 205 is a lock-in camera. Element 206 represents the optical axis. Element 207 illustrates the propagation of a bundle of rays. Element 208 is a second light source that is located at a location which is mirrored with respect to the optical axis 206 compared to light source 201. Element 209 illustrates the propagation of a bundle of rays from this second source 208.

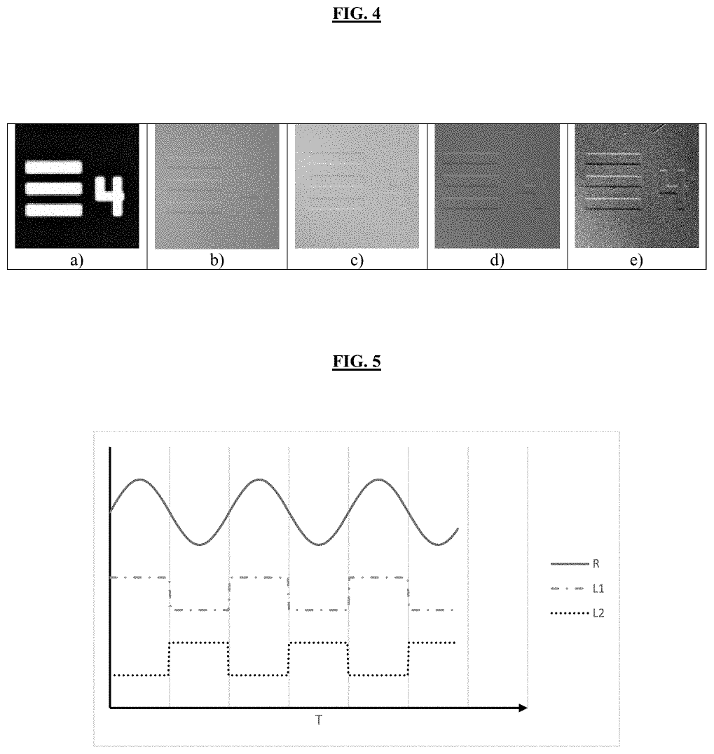

If the sample 202 is for example the one represented in FIG. 4a (where the white pixels represent small phase change and the black pixels represent big phase change), upon illumination with a light source 201 inclined from left to right (as in FIG. 3b), the image of FIG. 4b is formed in a normal camera instead of a lock-in camera. It can be seen that the borders along which a change of phase occurs are highlighted with dark or bright modulation against a background, where the polarity of this contrast depends on whether there is an increase or a decrease of phase in the direction of the illumination.

If the sample is additionally illuminated with the source 208 with opposite angle (as in FIG. 6), the image of FIG. 4c is obtained. This image is identical to the previous one, but with reversed contrast. As shown in Tian, L. and Waller, L. Quantitative differential phase contrast imaging in an LED array microscope. Optics Express. 2015, Vol. 23, 9, the absorption features of the sample look the same in both images, so upon subtraction they are canceled. In this way, only the relevant phase information is retained, as in FIG. 4d. If the phase variations are very small, the single image will contain a strong background component with small modulations on top thereof. In the case that this modulation is close to the noise level, the result of this subtraction is similar to FIG. 4e: a noisy, zero-mean image with low intensity features.

In the system according to the embodiment of the present invention shown in FIG. 6, the single image detection is substituted with the lock-in camera 205. Moreover, the illumination from the two sources 201 and 208 is modulated according to the timing scheme of FIG. 5. In this graph, the horizontal axis represents time. The line R is the reference sinusoidal signal, while L1 and L2 represent the output power of the two light sources 201 and 208. In this embodiment, the two sources emit light according to an on/off scheme represented by a square wave. The two waves L1 and L2 have the same frequency of the reference sinusoidal signal R, and they are in quadrature. One source is on during the peaks of the reference signal R, while the other is on during the valleys. To summarize, sources 201 and 208 are alternately switched on and off in synchronization with a lock-in signal, such that at any given time either light source 201 or 208 is emitting light, but not both at the same time. Camera 205 records a difference image between these two illumination states by lock-in amplification of the difference signal at each pixel. In this embodiment, the use of alternating oblique illumination allows to form an image on the detector showing the OPL distribution on the sample, or equivalently, the phase shift that it introduces to the upcoming light.

Other embodiments can be envisioned for phase contrast. In this case, the only requirement is to have an asymmetry in the imaging apparatus:
Any asymmetry in the illumination
Tilting/rotating the sample with a positioning element that can switch or modulate the position of said sample
Tilting/rotating extra phase plates
Tilting/rotating opaque stop elements between the illumination source and the sample.

By synchronizing any of these modulations to the reference sinusoidal signal, a similar result to that described above is obtained.

In an alternate embodiment of this invention, illumination is linearly polarized and the direction of polarization is modulated in synchronization with the lock-in signal. As a result, the lock-in camera records the difference image between two states of polarized illumination. It can be used for example to detect parts of a sample with a different response to these states of polarization, for example asymmetrical nanoparticles which absorb preferentially in one direction of polarization, or birefringent materials which refract light differently depending on polarization.

In a further alternate embodiment of this invention, the illumination is switched rapidly between two different wavelengths in synchronization with the lock-in signal. As a result, the lock-in camera records the difference image between two wavelengths of illumination. It can be used for example to record slight differences in the transmission, absorption or scattering of a sample between both wavelengths of illumination.

The present invention is suitable for imaging amplification of 1) any material having structures which possess either a different index of refraction than the surrounding space (in the volume of the material), or 2) samples that have a topography (i.e. surface) that is varying while the bulk index of refraction is the same, or a combination of those materials 1) and 2).

Examples for materials 1) include biological material such as native tissue, organoids, and 3D printed tissue. Examples for materials 2) and/or include semi-conductor wafers, electronics, solar cells, and additive printed electronics showing a combination of topography and index change.

The present invention will now be described with reference to non-limiting examples and drawings.

In this section, experimental results are discussed regarding the improvements in imaging obtained with the system according to FIG. 6. This setup was used to perform differential phase contrast imaging, as described previously. In particular, the illuminating sources 201 and 208 were LED with a wavelength of 635 nm, the objective lens 203 was a Nikon 20× magnification objective, the tube lens 204 was a doublet achromat. These choice of elements is non-limiting, and any other incoherent source and pair of objective and tube lens can be used without deviation from the scope of this invention. In order to compare this method to standard differential phase contrast, the same sample was imaged with a helicam C3 lock-in camera, once with the described lock-in method, and once with the detector used as a standard camera, where each pixel collected photons for the duration of the exposure time, and the number of photoelectrons was digitized over an 8-bit scale.

FIG. 7 shows a single image obtained in standard imaging mode, where only one of the two LEDs 201, 208 was on. The sample 202 used was a USAF target etched in glass. The grooves of this structure introduced a different path length compared to the surrounding glass, thus creating a phase difference that appeared on the detector as an intensity pattern. The depth of these grooves was only 20 nm, so the phase difference they introduced was of only 91 mrad, and the intensity pattern at the detector was very faint, as compared to the background. Indeed, the detector was illuminated with enough power to almost reach the saturation level, so that the SNR was maximized. Still, the sample structures were barely visible in this image.

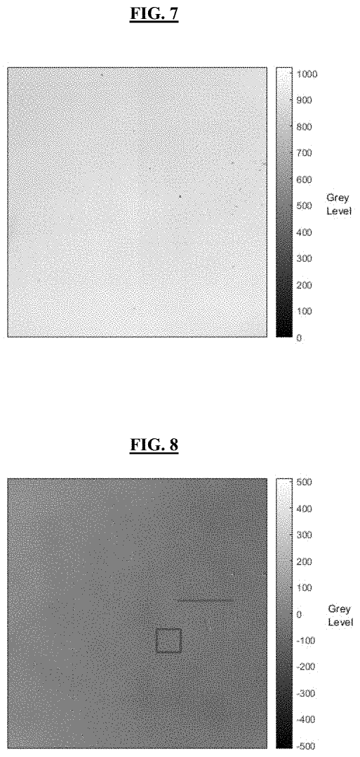

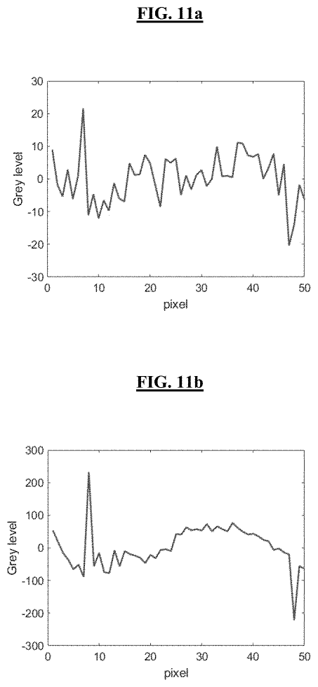

FIG. 8 shows the result of subtraction between the two images obtained with opposite illumination, and their difference was computed to remove the background, which is the procedure for differential phase contrast as described before. Since the illumination from the two LEDs 201, 208 was tuned to be as equal as possible, upon subtraction the background became almost zero, but the sample structures still appeared with very low contrast. The blue line indicates the location where the cross section of FIG. 11(a) was taken. The red square indicates the area where the standard deviation of pixel values was calculated.

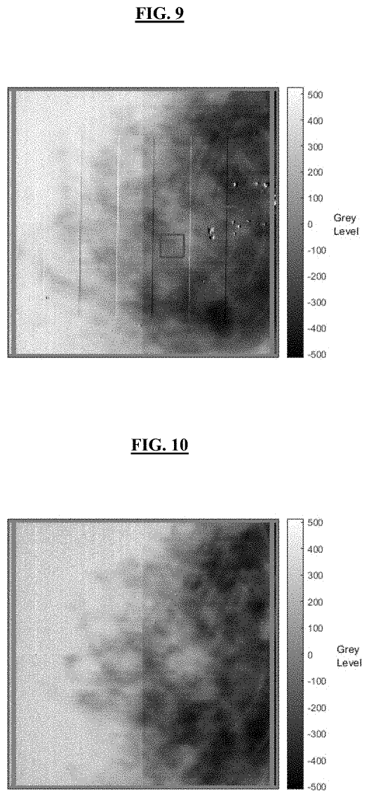

FIG. 9 shows the same sample imaged with the lock-in modality. In this case, the image already has zero background, and the 8 bits are all used to encode the structures, which indeed appear with a much stronger contrast. The blue line indicates the location where the cross section of FIG. 11(b) was taken. The red square indicates the area where the standard deviation of pixel values was calculated.

The pattern that appeared on top of the sample structures is due to differences between the two illuminations. Since this image was starting to show saturation, this is the limit to the increase of power with the current illumination system. With a more uniform illumination, it would be possible to obtain even more improvement.

The fixed pattern of illumination can be removed upon subtraction of a lock-in image obtained with no sample, as shown in FIG. 10.

In order to compare the two methods described above (differential phase contrast imaging and standard differential phase contrast), first the average amplitude of the cross section of the rectangular shapes was calculated. FIG. 11 shows two examples of cross sections:

(a) is a cross section from the standard differential phase contrast image, take along the blue line shown in FIG. 8;

(b) is a cross section from the lock-in differential phase contrast image according to the present invention, take along the blue line shown in FIG. 9.

It can be seen that the shape is similar, but the scale of grey levels is ten times higher in the lock-in cross-section according to the present invention. On average, according to the present invention the peak-to-peak amplitude is encoded over nine times more grey levels.

Further, the noise as the background free standard deviation of pixel values in the red areas shown in FIG. 8 and FIG. 9 was calculated. Subsequently, the SNR for both cases was computed, using the formula:

$$S N R = \frac{{A}_{ptp}}{σ}$$

where

Aₚₜₚ is the peak-to-peak amplitude and

σ is the standard deviation of the noise.

The resulting SNR for standard differential phase contrast was 5.9 while for the lock-in according to the present invention it was 31.2. This means that according to the present invention the SNR is improved by a factor of 5.2.

This can be further improved if an even more uniform illumination is used: in this case, the image would not be saturated yet, and the power of the sources could be further increased, thus bringing about even higher SNR values.

1.-15. (canceled)

16. An imaging system comprising at least one incoherent illumination source which can be switched or modulated between different states in synchronization with a lock-in signal, and a lock-in image camera to perform a lock-in amplification of a difference image at a pixel level.

17. The system according to claim 16, wherein at least one pair of incoherent illumination sources is asymmetrically located with respect to an optical axis.

18. The system according to claim 16, wherein said at least one or at least one pair of incoherent illumination source(s) is provided asymmetrically with respect to an optical axis of the system.

19. The system according to claim 16, further comprising an opaque stop element located asymmetrically with respect to an optical axis of the system, so that during operation part of an emission from the source is blocked by said stop element.

20. The system according to claim 16, further comprising at least one lens in the optical path between a sample and the lock-in camera.

21. The system according to claim 16, further comprising a positioning element which can switch or modulate a position of a sample between two mirrored states.

22. The system according to claim 16, further comprising an additional phase plate which can be switched or modulated between two mirrored states.

23. The system according to claim 16, wherein light from said at least one incoherent illumination source is linearly polarized and a direction of polarization of said linearly polarized light can be modulated or switched.

24. The system according to claim 16, wherein said at least one incoherent illumination source is variable, so that its wavelength can be modulated or switched.

25. A method to record a difference image of a sample, comprising the steps of:
modulating one or more parameters of an imaging system according to claim 16, in synchronization with a lock-in signal; and
recording with lock-in amplification an image representing a difference in appearance of said sample between the modulation states of said parameter or parameters.

26. The method according to claim 25, wherein said modulation comprises alternately switching illumination sources which are asymmetrically located with respect to an optical axis of said imaging system, said switching being synchronized with a lock-in signal, and an image representing a difference in appearance of said sample between the switching states of said illumination sources is recorded.

27. The method according to claim 25, wherein a calibration step is performed prior to the recording to obtain identical background values.

28. The method according to claim 25, wherein difference images obtained from at least one pair of different illumination sources are combined to retrieve a quantitative or qualitative phase image.

29. The method according to claim 25, wherein said modulation comprises switching or modulating a direction of polarization of at least one illumination source of the sample in synchronization with a lock-in signal, to record an image of said sample showing a difference in appearance of said sample between two states of polarized illumination from said at least one illumination source.

30. The method according to claim 25, wherein said modulation comprises switching or modulating a wavelength of at least one illumination source in synchronization with a lock-in signal, to record an image of said sample showing a difference in appearance of said sample between different wavelengths of illumination from said at least one illumination source.
